(19) United States
(12) Patent Application Publication
(10) Pub. No.: US 2012/0067250 A1
(43) Pub. Date: Mar. 22, 2012

(54) Dosing Bag Structure for Dispensing Fiber and Admixtures into Cementitious Mixtures

(76) Inventor: Paul E. Bracegirdle, Newtown, PA (US)

(21) Appl. No.: 13/237,916

(22) Filed: Sep. 20, 2011

Related U.S. Application Data
(60) Provisional application No. 61/384,699, filed on Sep. 20, 2010.

(51) Int. Cl. C04B 16/00

(52) U.S. Cl. 106/638

(57) ABSTRACT

A dosing bag for additives that are mixed into a cementitious mixture, wherein the dosing bag is made from a dissolvable starch-based film material. When the dissolving dosing bag with its contents are introduced into a mixture that uses water as an ingredient, the dosing bag dissolves at a particular rate such that the additives are released into the mixture in an even manner. The dosing bag has structural features that enable it to dissolve and release material over an extended period of time. Consequently, the material in the dissolving dosing bag is not released as a clump, but is rather released in a manner that ensures is even distribution during mixing. When the additives are more evenly dispensed throughout a mixture, the quality of the final product is greatly improved.

### RELATED APPLICATIONS

This application is a continuation-in-part of U.S. Provisional Patent Application No. 61/384,699, entitled Dosing Bag Structure For Dispensing Fiber And Admixtures And Its Method Of Manufacture, filed Sep. 20, 2010.

### BACKGROUND OF THE INVENTION

1. Field of the Invention

The present invention relates to prepackaged dosing bags for dry admixtures and/or fibers that are intended to be added to cementitious mixtures that contain water.

2. Prior Art Description

Fibers and/or other admixtures are often added to cementitious products such as concrete. Typically, fibers and/or admixtures are added immediately before or during the mixing of the cementitious product. Fibers and/or admixtures are used to improve or modify the cementitious material. Fibers and/or other admixtures are used to modify the properties of concrete in such a way as to improve the product, make the product more suitable for a particular purpose, or for economy. The primary reasons for using fibers and/or other admixtures in concrete are (1) to achieve certain properties in concrete more effectively than by other means; (2) to maintain a quality of concrete throughout the successive stages of mixing, transporting, placing, and curing; (3) to overcome certain emergencies during concrete making or placing operations; (4) to reduce the cost of concrete construction; and (5) to improve the mixture to control cracking or other detrimental effects. In most instances the desired effect within the cementitious material can only be achieved by the use of fibers or admixtures. In addition, the use of fibers and/or admixture allows the use of less expensive construction methods or designs and thereby offsets the costs of the add materials.

As an example, consider a mixing truck at the end of a delivery that still contains wet concrete within its mixer. If the wet concrete is left in the truck overnight, the residual product will set and begin to harden. While the wet concrete can be washed out of the truck with a large amount of water, the disposal of the liquid may cause an environmental problem. To avoid this problem, it is desirable to delay or retard the setting of concrete so that it remains fluid and can be used the next day. This affect is achieved by adding a retarding admixture to the wet cement. However, an exact amount of the admixture has to be added. If too much is added, the cement will not properly cure the next day. If too little is added, the concrete may harden prematurely.

Fibers and other concrete admixtures are typically provided as filaments, solids or powders. As such, they must be mechanically mixed into cement in order to be distributed. The more thorough the mixing, the more uniform the fibers and/or admixtures are dispersed. The successful use of these admixtures depends upon the accuracy with which they are prepared, the rate of which they are dispensed and the thoroughness of their distribution within the mixture.

Typically, concrete is made by weighing or volumetrically measuring the ingredients for a batch and introducing all ingredients into a wet mixer. It is important that the amount of fiber and/or admixture added during batching is carefully controlled. Inaccuracies in the amount of fiber or admixture added or the thoroughness of dispersion can significantly affect the properties and performance of the concrete products. The need for accuracy in measuring and having even dispersion of the amount of fiber or admixture to be added to a particular batch is particularly acute when a relatively small amount of fiber or admixture is required for the product.

For fibers and/or admixtures, it is cumbersome and time consuming to accurately weigh the required amount of additives. Thus, workers add fibers and/or admixtures to the concrete in pre-measured and pre-packaged bags. Such bags are known in the industry as dosing bags. The use of pre-measured dosing bags not only minimizes human error in handling and weighing but it also facilitates the process of mixing them into the product. One drawback of using dosing bags is that opening and emptying the pre-packaged dosing bags into the mixer creates a mess, wastes time, and results in some degree of spillage. The spillage contributes to inaccuracies in batching. It also exposes workers to chemicals and dusts that are best not inhaled.

Another drawback in using prior art dosing bags is that the typical dosing bags is made either from thin paper that is sealed with glue or with a heat seal strip. Workers often just throw these bags into a mix with no concern that the bag and the bag's seal will not dissolve into the mix. If this debris is not physically removed, it can create flaws in the final concrete product. Furthermore, the additives stuck within the bag tend to get trapped in the bag and clump up. Extra mixing time must therefore be used to ensure that the additives have the opportunity to disperse throughout the mixture.

Some attempts have been made to develop a dissolving dose bag from dissolvable films such as polyvinyl acetate or polyvinyl alcohol (PVA). Such prior art dosing bags are exemplified by U.S. Pat. No. 4,961,790 to Smith, entitled Concrete Admixture Device and Method Of Using Same. However, such prior art dosing bags are highly sensitive to the humidity in the air. Thus, such prior art dosing bags must be packaged and stored inside an air-tight bag or other low-moisture environment. This is highly impractical at most jobsites where concrete is being mixed for use. One humid night can ruin thousands of pounds of additives, if not stored properly at the jobsite.

Another problem associated with such prepackaged additives, is that the dissolvable packaging disintegrates so rapidly, that the additives held in the packaging never have the opportunity to disperse before they pass into the mixture. Again, the result is that the additives tend to clump together and remain clumped during the mixing process. Again, extra mixing is needed to ensure that the clumps are broken and that the additives have had the opportunity to disperse evenly throughout the mixture.

A need therefore exists for an improved packaging system for fibers and admixture that can be thrown directly into a cementitious mixture, where the package disperses its contents slowly and evenly, yet wherein the packaging completely dissolves. This need is met by the present invention as described below.

### SUMMARY OF THE INVENTION

The present invention is a dissolving dosing bag for fiber or other concrete admixtures that is made from a dissolvable starch-based film material. When the dissolving dosing bag with its contents are introduced into a mixture that uses water as an ingredient, and which is agitated for a period of time, the dissolving dosing bag dissolves at a particular rate such that the fiber or other concrete admixtures are released into the mixture in an even manner.

The dissolving dosing bag has structural features that enable it to dissolve and release material over an extended period of time. Consequently, the material in the dissolving dosing bag is not released as a clump, but is rather released in a manner that ensures is even distribution during mixing. When the fiber or other admixtures are more evenly dispensed throughout a mixture, the resulting final product is greatly improved. Furthermore, since the added material is very evenly distributed, often less fibers or admixtures are needed to be effective. The controlled release of the fibers and admixtures overcome the tendency of the fibers or other admixtures to ball up, clump, or suffer from improper dispersion or incomplete mixing.

The present invention further provides a method for fabricating the dissolving dosing bags. The starch-based film material of the dosing bags may be sealed using the application of heat. Using different heat settings, the film material proximate the heat seal can be altered to dissolve either faster or slower than the remainder of the doing bag. Such alterations are used to produce a dosing bag that releases its contents in a controlled manner over a prolonged period of time.

### BRIEF DESCRIPTION OF THE DRAWINGS

For a better understanding of the present invention, reference is made to the following description of an embodiment thereof, considered in conjunction with the accompanying drawings, in which:

FIG. 1 is a perspective view of an exemplary embodiment of a plurality of dosing bags;

FIG. 2 is a front view of a dosing bag;

FIG. 3 is a front view of a dosing bag after dissolving for a first period of time;

FIG. 4 is a front view of a front view of a dosing bag after dissolving for a second period of time;

FIG. 5 is a front view of a second embodiment of a dosing bag after dissolving for a first period of time;

FIG. 6 is a partially fragmented perspective view of a third embodiment of a dosing bag; and

FIG. 7 is a partially fragmented perspective view of a forth embodiment of a dosing bag.

### DETAILED DESCRIPTION OF THE INVENTION

Although the present invention dosing bag system can be embodied in many ways, the illustrations selected show only three variations of the invention. These embodiments are selected in order to set forth the best modes contemplated for the invention. The illustrated embodiments, however, are merely exemplary and should not be considered a limitation when interpreting the scope of the appended claims.

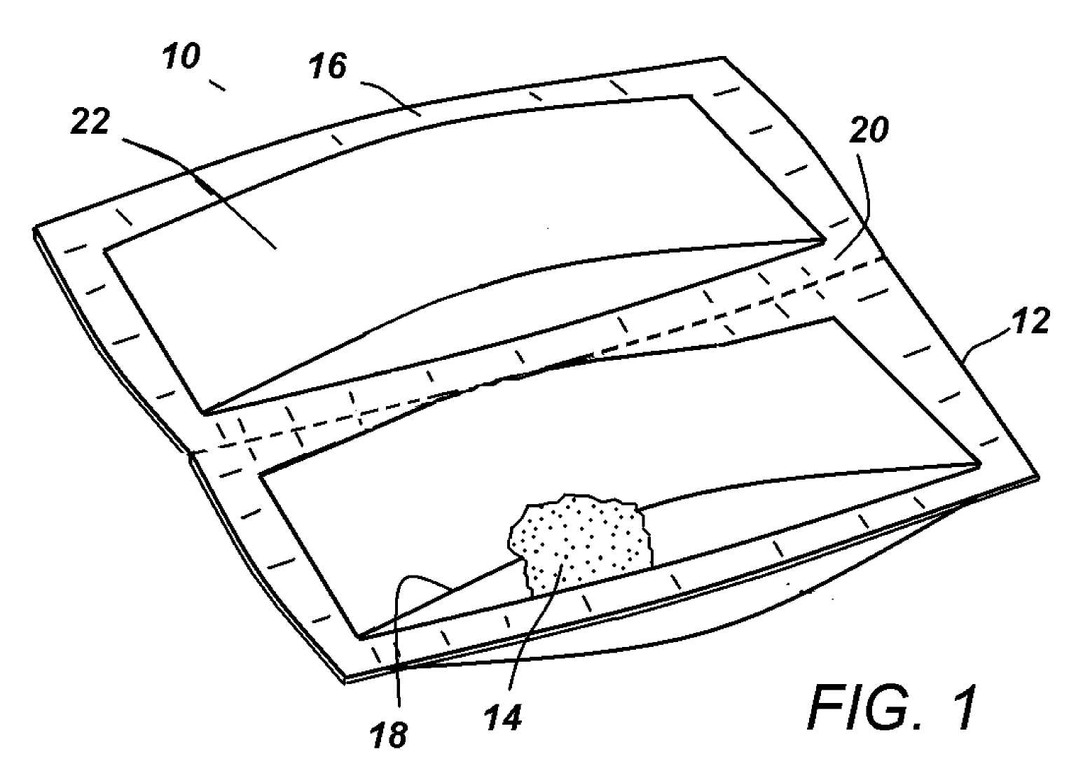

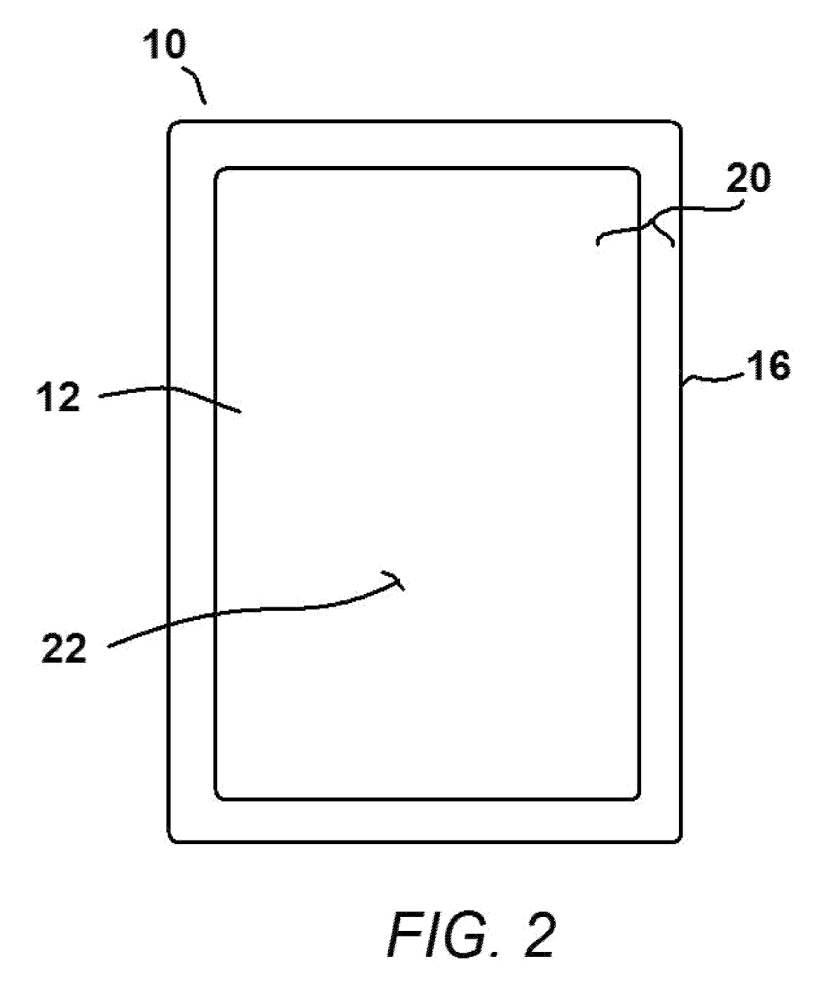

Referring to both FIG. 1 and FIG. 2, a first exemplary embodiment of a dissolving dosing bag 10 is shown. The dosing bag 10 is made from a starch-based water dissolvable film 12. The film 12 that is heat sealed around a volume of dry additive material 14. The dry additive material 14 can be fibers or any other dry or powdered admixture that a person may want to add to a cementitious mixture.

The dissolvable film 12 used to make the dosing bag 10 is a hygroscopic plastarch material PSM. Several formulations of such PSM materials are commercially available in the marketplace. The composition of a preferred PSM is described in U.S. Patent Application Publication No. 2008/0153958 to Ding, entitled Substantially Completely Biodegradable High Starch Polymer, the disclosure of which is incorporated into this specification by reference.

The dosing bags 10 are made by heat sealing seams 16 between and around deposits of the dry additive material 14. This creates sealed pockets 18 that isolate the dry additive material 14. The pockets 18 preferably hold less than 0.5 pounds of additive material 14 and may be so small that they hold only one or two ounces. During manufacturing, the dosing bags 10 are interconnected at the seams 16. The various interconnected dosing bags 10 are then packaged in larger boxes, such as a five pound box or a twenty pound box.

For example, suppose that at particular batch of cementitious material requires 16¾ pounds of reinforcement fibers for a particular application. Using the present invention system, the fibers can be prepackaged in ¼ pound dosing bags 10. Eighty such dosing bags 10 can then be packaged into a twenty pound box. To meet the requirement, a worker needs to open the box and toss sixty seven dosing bags 10 into the mix in order to precisely meet the 16¾ pound requirement without waste. The remaining thirteen remaining dosing bags 10 are saved for later use. Since the dosing bags 10 are tossed whole into a mixer, there is no labor wasted in measuring and dumping the fibers. Furthermore, since the dosing bags 10 are never opened by the worker, there is no danger of chemical contamination or inhalation hazards from the additive material 14.

The addition of multiple small dosing bags 10 into a mixer, rather than the addition of a few large bags greatly increases the thoroughness at which the additive material 14 is dispersed throughout the mixture. As a result, the likelihood that additive material 14 clumping will occur is greatly reduced.

The dissolvable film 12 is heat sealed along the seams 16 that surrounds a peripheral edge of the dosing bag 10. When the dosing bags 10 are heat sealed, the dissolvable film 12 becomes heated in the area of the seam 16. The degree of heating is inversely proportional to the distance from the seam 16. That is, the dissolvable film 12 is heated to into a bond along each seam 16. However, the dissolvable film 12 is inadvertently heat treated in the areas 20 adjacent to the heated seam 16 by the heating element that creates the seam 16.

It has been discovered that the dissolvability of the dissolvable film 12 is affected by such a heat treatment. The dissolvable film 12 dissolves in water. However, the rate at which the dissolvable film 12 dissolves can be either decreased or increased by heat treating the dissolvable film 12 when creating the seams 16. Consequently, the dissolvable film 12 at the seam 16 and in the heat treated areas 20 adjacent to the seam 16 can be made to dissolve either slower or faster in water than the untreated film 12 within the central areas 22 of the dosing bag 10.

The sealing of the dosing bag 10 can be achieved using many commercial plastic sealing machines. A preferred machine is the Model PSF-400 impulse heat sealing machine made by the Cleveland Equipment & Machinery Company of Memphis, Tenn. Using such sealing equipment, it has been discovered that using a sealing machine at low temperatures and with short sealing times creates heat treated areas 20 of the dissolvable film 12 that dissolve slower than the central areas 22 of the dosing bag 10. Conversely, it has been discovered that using a higher temperature setting for a longer period of time degrades the dissolvable film 12 and the heat treated areas 20 of the dissolvable film 12 can be made to dissolve faster than the central areas 22 of the dosing bag 10. Both phenomenons can be utilized by the present invention.

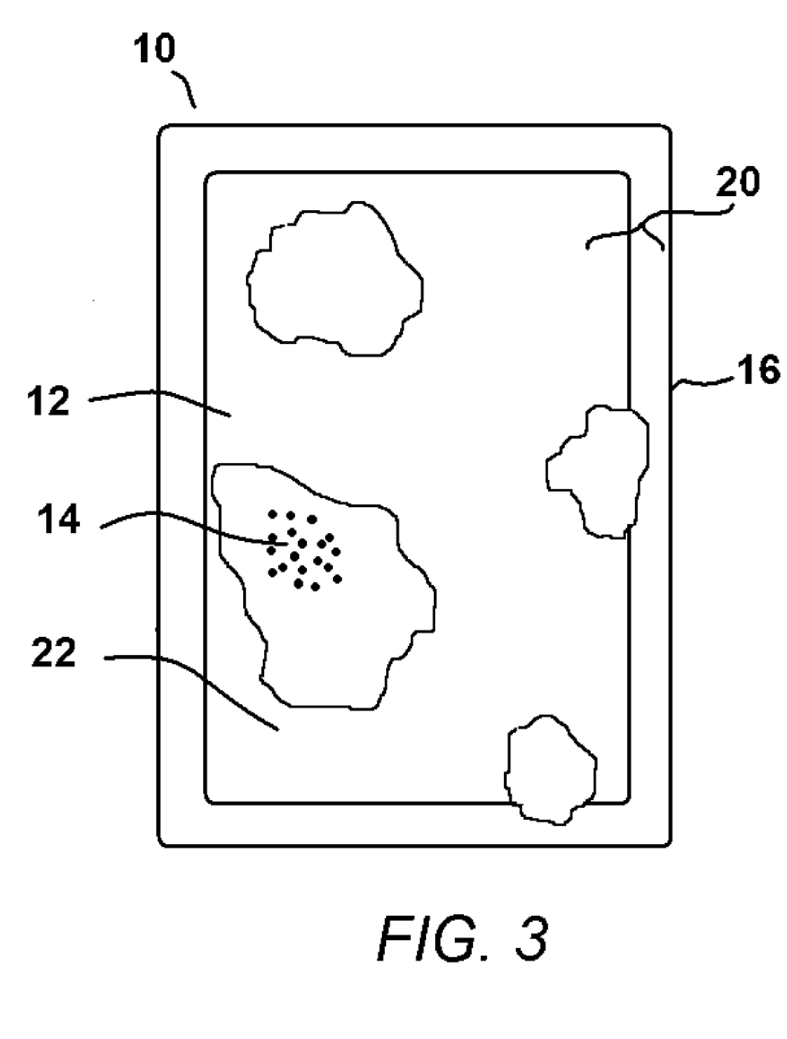

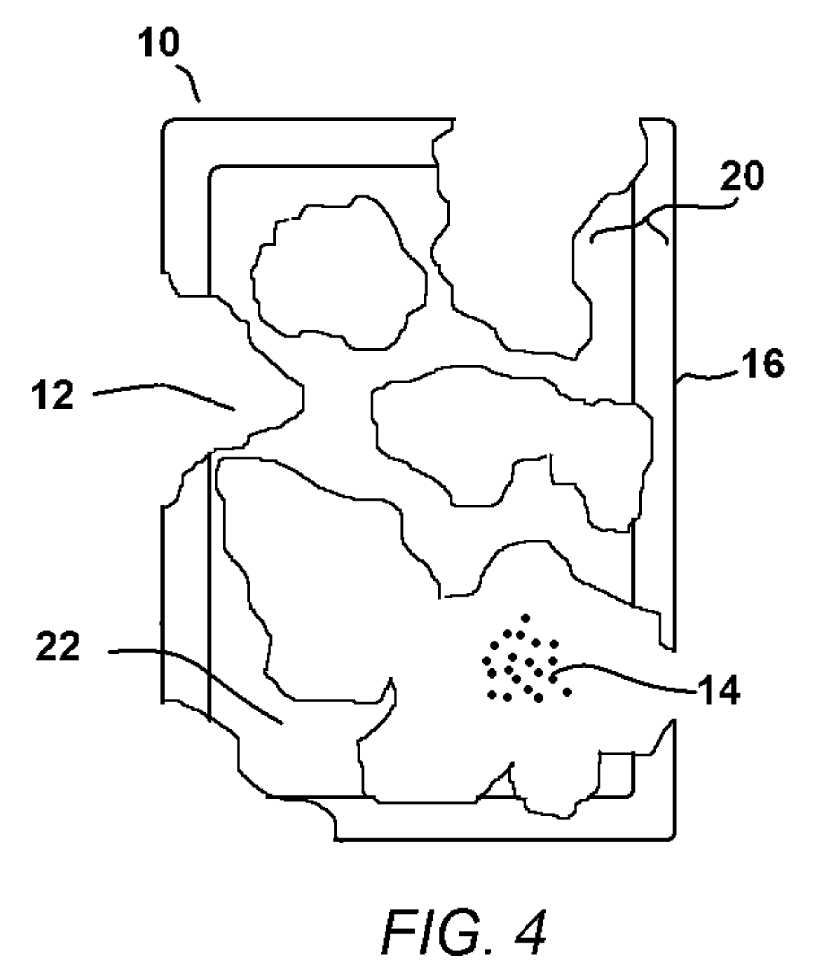

Referring to FIG. 2, FIG. 3 and FIG. 4, it will be understood that the instant before the dosing bag 10 is exposed to water in a wet mixer, the dosing bag 10 is intact and the contents of the dosing bag 10 are confined. This is shown in FIG. 2. Assuming that the dosing bag 10 was manufactured in the manner that makes the seams and heat treated areas 20 of the film 12, slower to dissolve than the central areas 22 of the dosing bag 10. In this scenario, after a short period of time, such as 5 seconds-10 seconds, the central areas 22 of the dosing bag 10 begin to loose integrity. This releases some of the additive material 14 stored within the dosing bag 10. This is shown in FIG. 3. After the passage of another short period of time, the heat treated areas 20 of the dosing bag 10 begin to dissolve. This releases the remainder of the additive material from inside the dosing bag 10. This is shown in FIG. 4.

It will therefore be understood that when the dosing bag 10 is thrown into a wet mixer, it begins to dissolve and release its contents. However, this process is not instantaneous. Rather, the additive materials 14 are released over a prolonged period of time that can last between twenty seconds and ninety seconds. This relative slow release of the additive materials 14 is occurring during the mixing of the cementitious material. As a result, the additive material 14 is provided with the opportunity to be thoroughly dispersed throughout the cementitious mixture without any clumping.

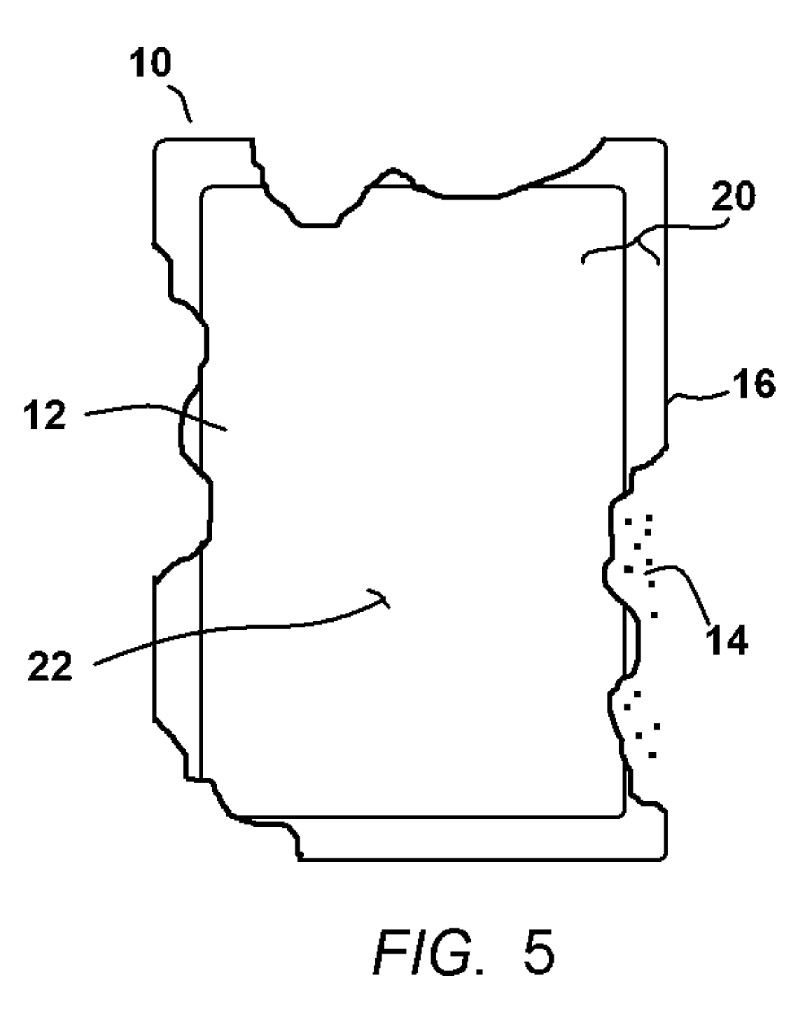

A similar effect can be achieved by making the seams 16 of the dosing bag 10 dissolve at a faster rate than does the central areas 22 of the dosing bag 10. Starting with the dosing bag 10 shown in FIG. 2, it can be seen that the dosing bag 10 is intact as it is thrown into a wet mixer. Referring now to FIG. 5, it can be seen that after a few seconds, the seams 16 and heat treated areas 20 begin to dissolve first. This released some of the additive material 14 from various points around the dosing bag 10. After several more seconds, total integrity of the dosing bag 10 is lost and all of the additive material 14 is released.

It will therefore be understood that when the dosing bag 10 is thrown into a wet mixer, it begins to dissolve and release its contents. However, this process is not instantaneous. Rather, the additives are released over a prolonged period of time that can last between twenty seconds and ninety seconds. As a result, the additive materials 14 are provided with the opportunity to be thoroughly dispersed throughout the cementitious mixture without any clumping.

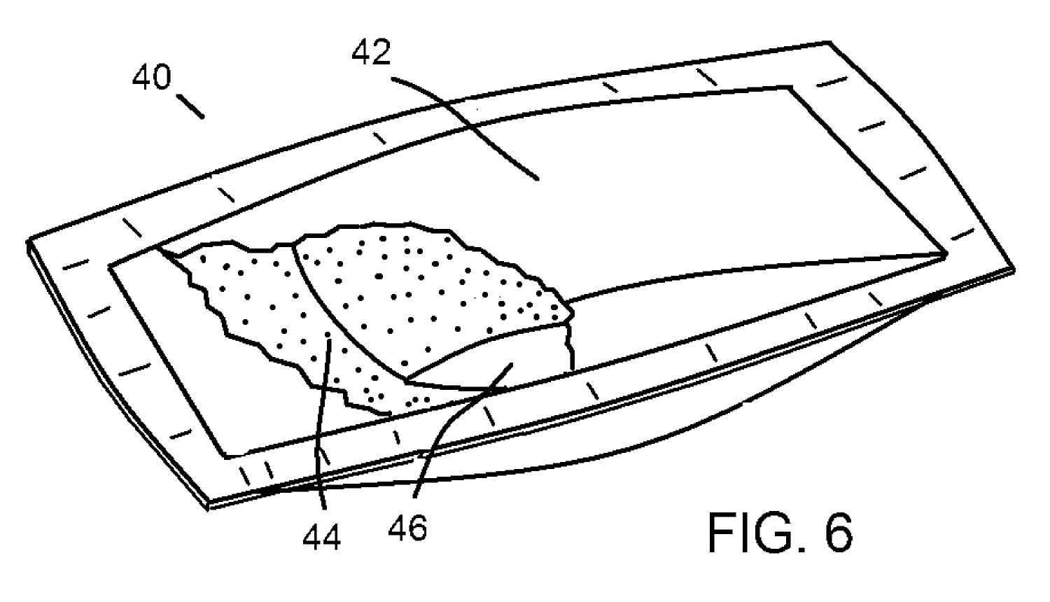

Referring now to FIG. 6, another embodiment of the dosing bas 30 is shown. In this embodiment, the dissolving film 32 need not have a uniform construction. Rather, in selected sections 34 of the dosing bag 10, the dissolvable film 12 can be either thinned or heat treated to rapidly dissolve. In these selected sections 34, the dissolvable film 32 preferably will dissolve 30% and 70% faster than in other regions of the dosing bag 30.

It will be understood that when the dosing bag 30 is placed in a mixer and is exposed to water, the selected sections 34 will dissolve away before the rest of the dosing bag 30. Likewise, the agitators within the mixer are likely to cause tears in and around the selected sections 34 before tearing the other areas of the dosing bag 10. Consequently, when the dosing bag 10 is thrown into a mixer, the selected sections 34 open first and release the contents of the dosing bag 30 at a controlled rate. As a consequence, the dosing bag 30 begins to empty. Eventually, the entire dosing bag 30 dissolves, thereby ensuring that the contents of the dosing bag 30 are released.

Due to the selected sections 34 of the dosing bag 30, the dosing bag 30 will continuously release its contents over a span of about thirty seconds to ninety seconds. At the end that period of time, the dosing bag 30 dissolves to a point where it loses all structural integrity and all of its contents are released.

In a mixer, where there are moving agitators and a volume of cementitious material, mixing occurs fairly rapidly. A dosing bag 30 that releases material in a sixty-second timeframe enables the material being dispensed to fully intermix throughout the cementitious mixture. Furthermore, since the dosing bag 30 releases its contents over this prolonged period of time, there are no clumps or balls of material that can pass through the mixer without being properly integrated.

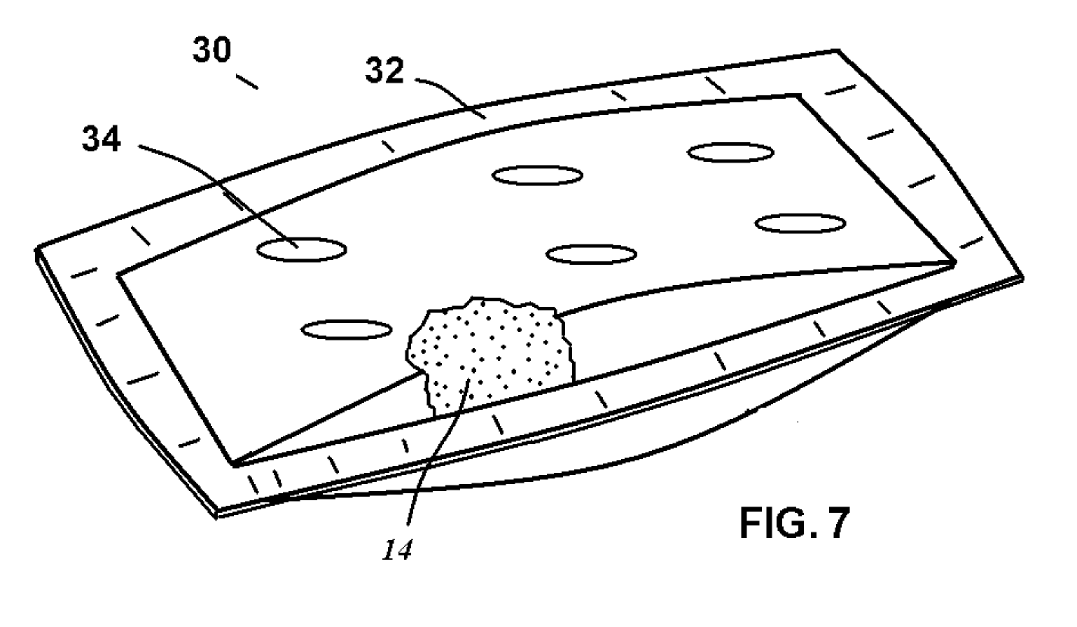

Referring to FIG. 7, an alternate embodiment of a dissolving dosing bag 40 is shown. In this embodiment, there is a primary bag 42. Inside the primary bag 22 are fibers or admixture material 44 as well as at least one secondary bag 46. The secondary bag 46 is also filled with the fibers or admixture material 44.

When the dosing bag 40 is placed in a mixer, the primary bag 42 dissolves away and releases a first volume of the fibers or admixture material 44. The secondary bag 46 is then exposed to the water in the mixer. The secondary bag 46 eventually dissolves and releases a second volume of fiber or admixture material 44.

If there is more than one secondary bag 46 disposed within the primary bag 42, each secondary bag 46 may have a different bag thickness so that they dissolve away at different rates.

The bag within a bag construction enables the fiber and admixture material 44 to be dispensed for prolonged periods of time within a mixer. Depending upon the number of secondary bags 46 used, the complete dispensing process can be prolonged over a period of a few minutes.

In all the described embodiments, the term water dissolvable as used herein denotes a physical or a chemical property of the starch-based film material. It means that the film will completely dissolve in water, either cold or warm and after only a brief period of time. Prior art bag materials, such as foam, cellulose, paper products, cotton products, and plastic are not dissolvable.

It can be seen from the foregoing discussion that the present invention solves most of the problems encountered in the prior art practice. It is believed that the operation and construction of the present invention will be apparent from the foregoing description. While the method and device shown and described have been characterized as being preferred, it will be obvious that various changes and modifications may be made therein without departing from the spirit and scope of the invention as defined in the claims.

What is claimed is:

1. A method of introducing a selected weight of additives to a cementitious mixture being mixed in a wet mixer, said method comprising the steps of:
creating a plurality of dosing bags, wherein each of said dosing bags contains a predetermined weight of said additives that is a whole number derivative of said selected weight, wherein each of said dosing bags is formed from a starch-based film that is dissolvable in water;
adding a plurality of dosing bags into said wet mixer with said cementitious material, wherein said predetermined weight of said additives in said plurality of bags add up to said selected weight, and wherein said starched-based film of said plurality of dosing bags dissolves in said wet mixer and releases said additives, wherein said mixer distributes said additives throughout said cementitious material.

2. The method according to claim 1, wherein said step of creating a plurality of dosing bags includes creating dosing bags that contain different areas designed to dissolve at different rates, therein releasing said additives over a predetermined period of time within said wet mixer.

3. The method according to claim 1, wherein said step of creating a plurality of dosing bags includes creating dosing bags with heat sealed seams and heat treated areas proximate said seams.

4. The method according to claim 3, wherein said heat treated areas surround central areas on each of said dosing bags dissolve slower than said central areas.

5. The method according to claim 3, wherein said heat treated areas surround central areas on each of said dosing bags and said heat treated areas dissolve faster than said central areas.

6. The method according to claim 1, wherein said step of creating a plurality of dosing bags includes providing dosing bags that hold between one ounce and one pound of said additives.

7. The method according to claim 1, wherein said step of creating a plurality of dosing bags includes creating dosing bags with sealed seams that surround central areas on each of said dosing bags.

8. The method according to claim 7, wherein said central areas contained thinned sections that dissolve quicker in water than do remaining sections.

9. The method according to claim 1, wherein said step of creating a plurality of dosing bags includes creating primary dosing bags and placing at least one secondary dosing bag within each of said primary dosing bags, wherein each of said primary dosing bags and each said secondary dosing bag contains said additives.

10. The method according to claim 9, wherein each said secondary dosing bag dissolves at a different rate than each of said primary dosing bags.

11. A method of introducing a selected weight of additives to a cementitious mixture, said method comprising the steps of:
creating a plurality of dosing bags, wherein each of said dosing bags contains a predetermined weight of said additives, wherein each of said dosing bags is formed from a starch-based film and embodies different areas that completely dissolvable in said cementitious mix at different rates;
mixing a plurality of dosing bags with said cementitious material in a wet mixer, wherein said different areas of said dosing bags dissolves in said wet mixer at said different rates and distributes said additives throughout said cementitious material.

12. The method according to claim 11, wherein said step of creating a plurality of dosing bags includes creating dosing bags with heat sealed seams and heat treated areas proximate said seams.

13. The method according to claim 12, wherein said heat treated areas surround central areas on each of said dosing bags dissolve slower than said central areas.

14. The method according to claim 12, wherein said heat treated areas surround central areas on each of said dosing bags and said heat treated areas dissolve faster than said central areas.

15. The method according to claim 11, wherein said step of creating a plurality of dosing bags includes providing dosing bags that hold between one ounce and one pound of said additives.

16. The method according to claim 11, wherein said step of creating a plurality of dosing bags includes creating dosing bags with sealed seams that surround central areas on each of said dosing bags.

17. The method according to claim 16, wherein said central areas contained thinned sections that dissolve quicker in water than do remaining sections.

18. The method according to claim 11, wherein said step of creating a plurality of dosing bags includes creating primary dosing bags and placing at least one secondary dosing bag within each of said primary dosing bags, wherein each of said primary dosing bags and each said secondary dosing bag contains said additives.

19. The method according to claim 18, wherein each said secondary dosing bag dissolves at a different rate than each of said primary dosing bags.
